(19) United States
(12) Patent Application Publication
(10) Pub. No.: US 2022/0258527 A1
(43) Pub. Date: Aug. 18, 2022

(54) Ribbon Decoration Device

(71) Applicant: ZEZ Solution, Inc., Denver, CO (US)

(72) Inventor: Saba Kragt, Castle Pines, CO (US)

(21) Appl. No.: 17/662,448

(22) Filed: May 9, 2022

Related U.S. Application Data
(63) Continuation of application No. 16/668,856, filed on Oct. 30, 2019, now Pat. No. 11,338,610.
(60) Provisional application No. 62/754,766, filed on Nov. 2, 2018.

(51) Int. Cl. B44C 3/12; A47G 33/08

(52) U.S. Cl. CPC B44C 3/12; A47G 33/0863

(57) ABSTRACT

An example ribbon decoration device includes a base structure. At least one end fastener may attach a first end of the base structure to a second end of the base structure for positioning the base structure on an object (e.g., around a portion of a tree, pole, fixture, window, doorway, or other object). Ribbon fasteners are configured to attach decorative ribbons to the base structure. The base structure is positioned on the tree, pole, fixture, window, doorway, or other object with the decorative ribbons in the rolled configuration, and then the decorative ribbons are unrolled for decorating the tree, pole, fixture, window, doorway, arch, or other object.

### BACKGROUND

This application is a continuation of U.S. patent application Ser. No. 16/668,856 filed Oct. 30, 2019 for “Ribbon Decoration Device” of Saba Kragt, which claims the priority filing benefit of U.S. Provisional Patent Application No. 62/754,766 filed Nov. 2, 2018 for “Ribbon Decoration Device” of Saba Kragt each hereby incorporated by reference in its entirety as though fully set forth herein.

### BACKGROUND

Ribbons are often used for decoration and to decorate for holidays or special events (e.g., birthday parties, weddings, etc.). Ribbons are typically provided on individual cardboard or plastic rolls that need to be cut to length. Stringing these ribbons for decorating requires each roll of ribbon be unrolled, cut to the desired length, and then placed where desired for decoration. Although ribbon decorations are aesthetically pleasing, this sort of decorating can be tedious and time-consuming. The ribbons are typically disposed of after each use because there is no effective way to store the ribbons without the ribbons becoming tangled.

### BRIEF DESCRIPTION OF THE DRAWINGS

FIG. 1 is a perspective view of an example ribbon decoration device in a closed configuration.

FIG. 2 is a perspective view of the example ribbon decoration device of FIG. 1 in a partially open configuration with several ribbons unfastened and partially unrolled.

FIG. 3 is a perspective view of the example ribbon decoration device of FIG. 1 with several decorative ribbon covers unfastened and removed from the decoration device.

FIG. 4 shows the example ribbon decoration device of Figurel encircling a top portion of a pole or architectural column.

FIG. 5 is a perspective view of another example ribbon decoration device in a closed or partially closed configuration.

FIG. 6 shows the example ribbon decoration device of FIG. 5 encircling the top of a Christmas tree.

FIG. 7 shows the example ribbon decoration device of FIG. 5 encircling the top of a Christmas tree, with one ribbon unfastened and unrolled.

FIG. 8 shows a Christmas tree with a ribbon decoration device encircling its top, and two ribbons unfastened and unrolled.

FIG. 9 shows a Christmas tree with a ribbon decoration device encircling its top, and a single ribbon unfastened, unrolled, and wrapped around the Christmas tree.

### DETAILED DESCRIPTION

A ribbon decoration device is disclosed. In an example, the ribbon decoration device provides an easy, user-friendly system for decorating with one or more ribbons, and can be employed to decorate a variety of structures (e.g., poles, columns, trees, chandeliers, etc.). Although shown and described herein for purposes of illustration as decorating a Christmas tree, the device can also decorate any object(s) for any occasion (e.g., weddings, birthdays, graduations, Christmas, New Year's Eve, Easter, Valentine's Day, Halloween, Thanksgiving, etc.).

In an example, one or more decorative ribbon or ribbons are attached to a base structure. The ribbons may be rolled and temporarily fastened (e.g., by removable attachment (e.g., snaps, studs, pins, stitching, sewing, hook-and-loop). The rolled ribbons may be attached to the base structure (e.g., a base structure) by any of permanent attachment (e.g., stitching, adhesive) or removable attachment (e.g., snaps, studs, pins, stitching, sewing, hook-and-loop or VELCRO™, etc.).

The decorative ribbons and base structure may be any of a wide variety of materials, designs, patterns, size, length, width, quantity, or quality, etc. The decorative ribbon which streams down from the base structure may also include attachments to attach additional decorations and ribbons. For example, other decorations may be provided to change the theme of the ribbon (e.g., from birthday to holiday) by removing and adding decorations (e.g., birthday cake buttons to wreaths) to the ribbon. The decorative ribbon which streams down from the base structure may also include attachments to lengthen and shorten the decorative ribbon or ribbons to provide for a continuous flow in decorating. Other decorations may also be attached to the ribbon(s) and/or the base structure.

In an example, the ribbon decoration device may be designed to fit 6 to 12 foot structures such as columns, poles and Christmas trees for the mainstream market. However customization may allow the ribbon decoration device to fit larger or smaller structures, trees, buildings, or other items. The decorative ribbon covers may also be implemented as extensions to lengthen the base structure.

The base structure may also be adjustable (e.g., in circumference and/or length) to fit around various sizes poles, columns, trees, or across doors, windows, or on any other structure on which it is installed. The base structure may be customized to attach any number of ribbons, and any width, length, material, style, etc. of ribbons. The ribbons may be mass-produced or custom-made for particular applications.

The ribbon decoration device provides an easy, user friendly system to use in decorating with one or more ribbons. It can be customized with a wide variety of ribbon types, lengths, widths, colors, styles, quantities, qualities, shapes, and designs.

Before continuing, it is noted that as used herein, the terms “includes” and “including” mean, but is not limited to, “includes” or “including” and “includes at least” or “including at least.” The term “based on” means “based on” and “based at least in part on.”

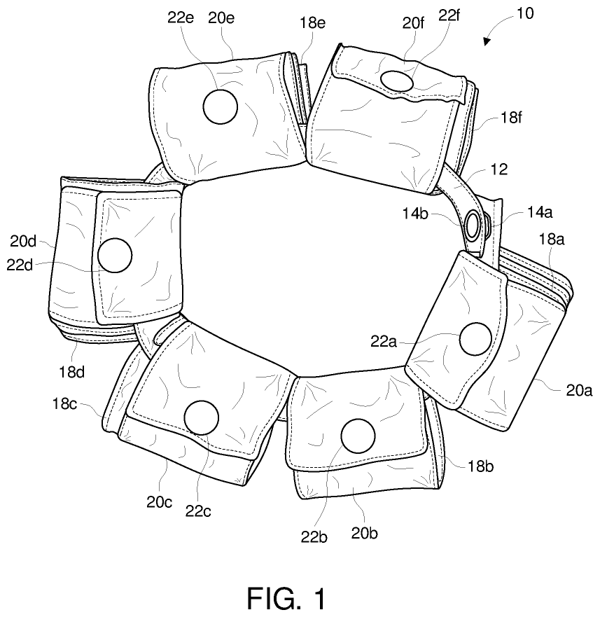

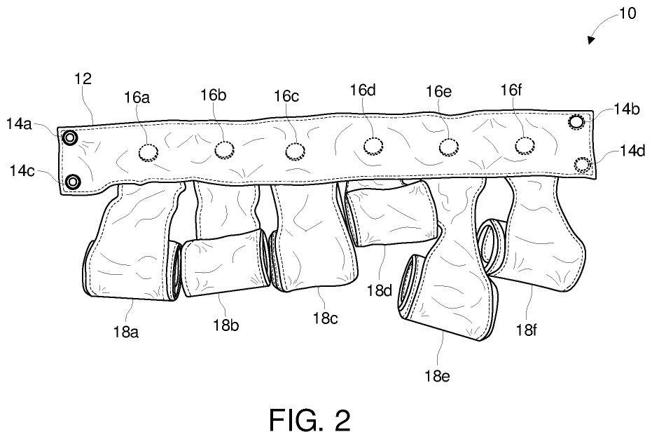

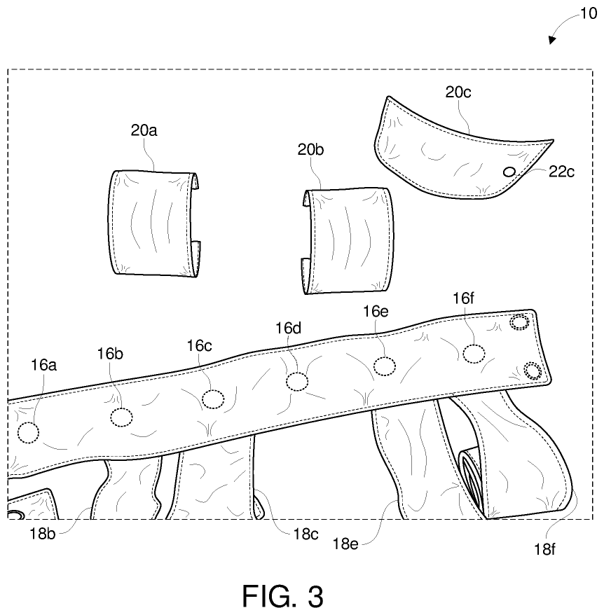

FIG. 1 is a perspective view of an example ribbon decoration device 10 in a rolled or closed configuration. FIG. 2 is a perspective view of the example ribbon decoration device 10 of FIG. 1 in a partially unrolled or open configuration with several of the ribbons 18a-f unfastened and partially unrolled. FIG. 3 is a perspective view of the example ribbon decoration device 10 of FIG. 1 with several decorative ribbon covers 20a-f unfastened and removed from the decoration device 10.

An example of the ribbon decoration device 10 includes a base structure 12 having a first end, a second end, and a body. At least one end fastener 14a-d is provided on each end of the base structure 12 to attach the first end of the base structure 12 to the second end of the base structure 12. As such, the base structure 12 may be formed as a straight, substantially straight or other layout including closing the ends to form a loop (e.g., circle, square, or other loop).

One or more decorative ribbons 18a-f may be removably attached to the body of the base structure 12. In an example, the ribbons 18a-f are attached with ribbon fasteners 16a-f (e.g., snaps, hook-and-loop or VELCRO TM, etc.). Fasteners 16a-f are shown in dashed lines as these may not be visible on the front of the base structure 12. Of course, other attachments may also be provided. In addition, the ribbons 18a-f do not need to be removably attached to the base structure 12, and may instead be permanently affixed (e.g., sewn to the base structure 12). The decorative ribbons 18a-f are configurable between a rolled configuration for storage and an unrolled configuration for decorating.

In an example, one or more decorative ribbon covers 20a-f are provided to retain the decorative ribbons 18a-f, respectively, in the rolled-up configuration. In an example, the decorative ribbon covers 20a-f are each long enough to fully wrap around a respective one of the decorative ribbons 18a-f when in the rolled-up configuration. The decorative ribbon covers 20a-f may include cover fastener(s) 22a-f to form a closed loop around the decorative ribbons 18a-f in the rolled-up configuration and retain the decorative ribbons 18a-f therein so that the decorative ribbons 18a-f do not unroll while in the rolled configuration.

In the closed or rolled configuration, the base structure 12 can be readily positioned on a tree, pole, fixture, window, doorway, or other object with the decorative ribbons 18a-f rolled up. This enables the base structure 12 to be more readily set in position without the ribbons 18a-f interfering with placement. After being properly positioned, the ribbon(s) 18a-f unrolled for decorating the tree, pole, fixture, window, doorway, or other object.

In an example, the base structure 12 is placed around a portion of the tree, pole, fixture, window, doorway, or other object, with the at least one end fastener attaching the first end of the base structure to the second end of the base structure.

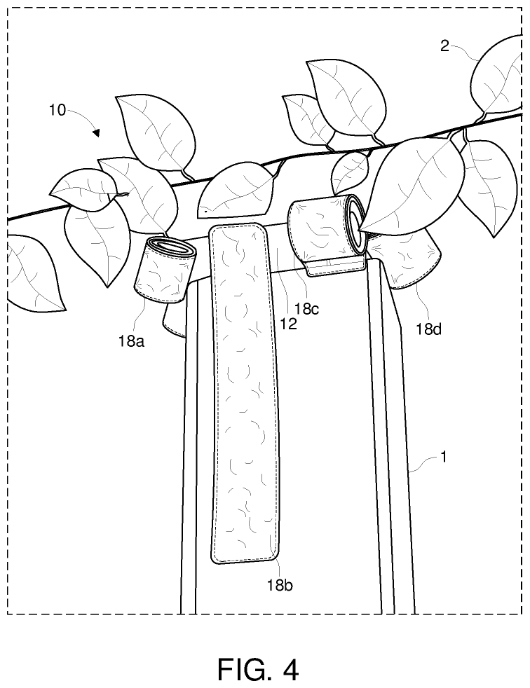

FIG. 4 shows the example ribbon decoration device 10 of FIG. 1 encircling a top portion of a pole or architectural column 1 (e.g., having other decoration such as leaves 2). In an example, after placement and when the user is ready, the decorative ribbon covers 20a-f may be opened, and one or more (e.g., all of) the decorative ribbons 18a-f unrolled, either straight down the pole or spiraled around it.

The ribbons (e.g., 18b) may be attached on the back of the base structure 12 and hang down from behind the base structure. In another example, the ribbons may be attached on the back and loop over the top of the base structure before hanging down. In another example, the ribbons may be attached on the front of the base structure 12.

In an example, the ribbons 18a-f may be twisted and/or even tied in fanciful knots or bows. Multiple ribbons may be combined into a composite ribbon(s). Other decorations may also be attached to the ribbon(s) and/or base structure 12. The decorating possibilities are limited only by the desires of the user.

Other examples of the device 10 and its many end-uses are also contemplated. By way of non-limiting illustration, another base structure (the same or similar to base structure 12) may be provided, and each of the base structures connected together to form an extended base structure for use with a larger tree, pole, fixture, or other object. In another illustration, at least two decorative ribbons (e.g., ribbon 18a and 18b or another ribbon, not shown) may be attached to one another, end-to-end (e.g., directly or via the covers implemented as an interconnection). The combination of the decorative ribbons form an extended length decorative ribbon. In yet another illustration, at least two decorative ribbons may be attached to the base structure 12 at the same point (e.g., 16a) and rolled/unrolled together. In another illustration, the decorative ribbons 18a-f may be attached on either side of the base structure 12 (e.g., on the front and/or back side) and may hang down or first wrap up and over the base structure before hanging down.

Before continuing, it should be noted that the examples described above are provided for purposes of illustration, and are not intended to be limiting. Other devices and/or device configurations may be utilized to carry out the operations described herein.

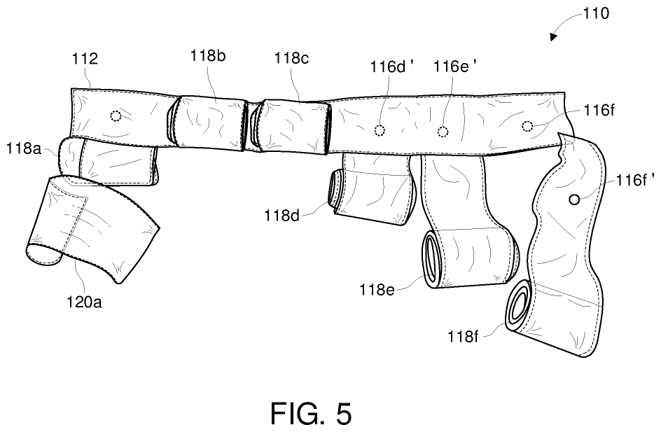

FIG. 5 is a perspective view of another example ribbon decoration device 110 in a closed or partially-closed configuration. The ribbon decoration device 110 is similar in that it includes a base structure 112 with one or more end fasteners (not visible in FIG. 5), such that it can be formed in a substantially circular shape or unfastened into a substantially linear shape. In this example, the materials and width of the base structure and ribbons are different than in the previous example. However, its principles of operation, and the effects thereof, are similar. As such, in FIGS. 5-9, 100-series reference numbers are used to refer to similar components as those already described above for FIGS. 1-4, without repeating those descriptions herein.

The base structure 112 includes a plurality of snaps or other ribbon fasteners 116 (ribbon fasteners 116d′, 116e′ on the ribbons 118d and 118e, respectively; and ribbon fasteners 116 and corresponding fastener 116′, are visible in FIG. 5). The ribbon fasteners are provided along the length of the body of the base structure 112 and serve as attachment points for one or more decorative ribbons 118a-f. The decorative ribbons 118a-f may be rolled up and snapped closed in a detachable cover (e.g., cover 120a is shown in FIG. 5), such that the ribbon decoration device 110 includes a plurality of decorative ribbons in a secure and compact configuration for storage and positioning the base structure 112 for decoration (e.g., on a tree top).

Once the attachments that secure a decorative ribbon cover 120a to the base structure 112 have been unfastened, the decorative ribbon 118a may be fully or partially unrolled, or may be removed from the ribbon decoration device 110 as an aesthetic choice.

The covers 120a serve a dual purpose that can be used to increase the circumference and length of the ribbons 118a-f. For example, the covers 120a may optionally be attached between ribbons to one another to form a smaller number of longer ribbons. In an example, the ribbon covers extend and lengthen the base structure and the ribbons that come off of the base structures attach to one another to lengthen the ribbon. In another example, the ribbons and/or base structures may be directly connected to one another. Connection may be by any suitable means, including but not limited to, buttons, snaps, hook-and-loop or VELCRO™, etc.

In another example, the decorative ribbon covers 120a may also be used as extensions to lengthen either the base structure 112 or one or more of the decorative ribbons 118a-f.

Of course, the devices 10 and 110 described herein are not limited to use with ribbon covers. It is also possible for the decorative ribbons to snap directly to the base structure in a rolled-up configuration, allowing for a coverless design.

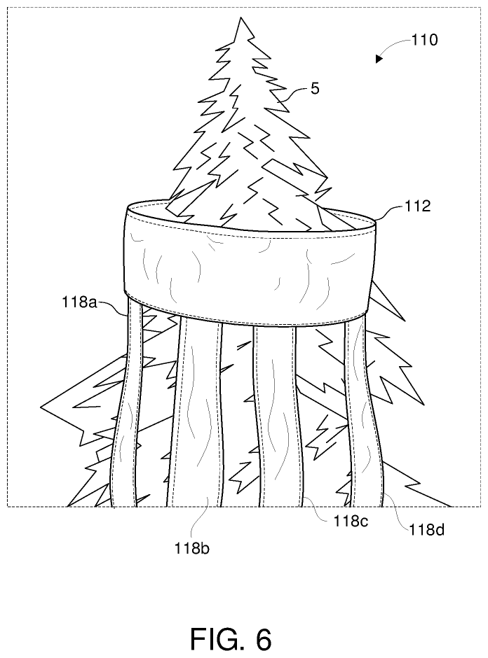

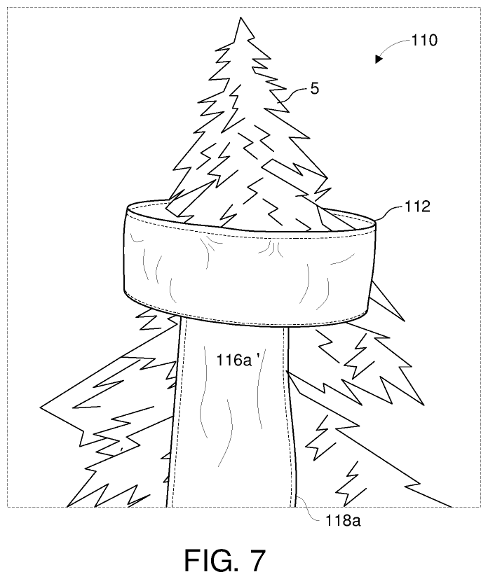

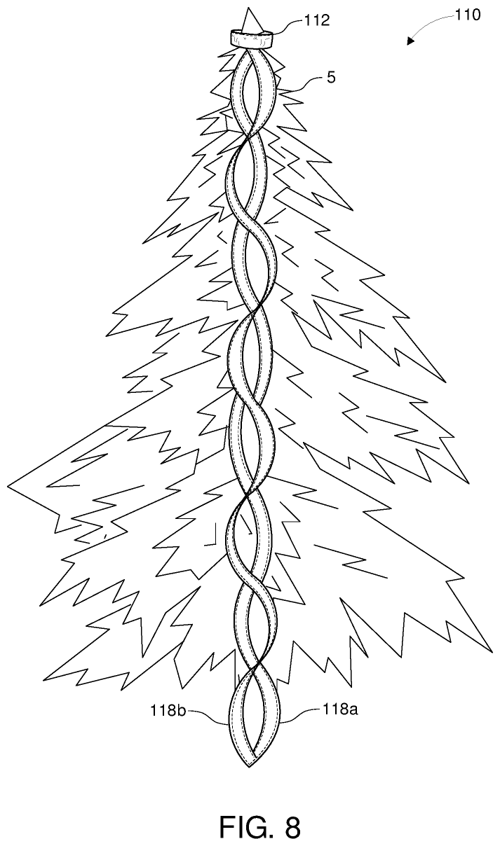

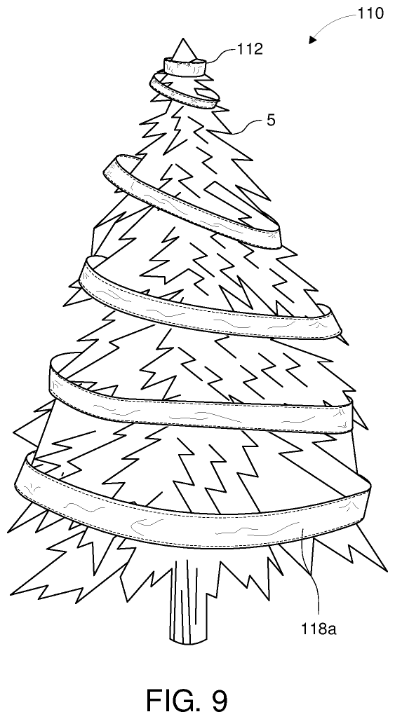

FIG. 6 shows the example ribbon decoration device 110 of FIG. 5 encircling the top of a Christmas tree 5. FIG. 7 shows the example ribbon decoration device 110 of FIG. 5 encircling the top of a Christmas tree 5, with one ribbon unfastened and unrolled. Additional ribbons 118a-f may be attached to provide length and/or volume. FIG. 8 shows a Christmas tree 5 with a ribbon decoration device 110 encircling its top, and two ribbons 118a and 118b unrolled and twisted together. FIG. 9 shows a Christmas tree 5 with a ribbon decoration device 110 encircling its top, and a single ribbon 118a unrolled and wrapped around the Christmas tree 5. In an example, a single ribbon may be used, or multiple ribbons may be attached to one another to form a longer combined or composite ribbon (e.g., of the same or similar texture, color, style, etc., or even different textures, colors, styles, etc.).

In an example, gravity and/or manual force may have unrolled the decorative ribbon(s), such that it reaches downward along the exterior of the Christmas tree 5 for most of the height of the Christmas tree 5, though not so far that it actually touches the floor. Although it may also touch the floor if desired.

As an aesthetic choice, a user may unroll some, all or none of the decorative ribbons 118a-f in order to decorate a plant such as a Christmas tree 5 or other object.

The decorative ribbon(s) 118a-f may each be a single long ribbon, or may be a composite ribbon made by attaching multiple decorative ribbons together as described above.

As an aesthetic choice, a user may deploy the decorative ribbons 118a-f vertically along the outside of the tree 5 or other object. Or the user may wrap the ribbons 118a-f around the outside of the tree 5 or other object. Or the user may entwine the ribbons 118a-f with the branches of the tree 5 or other object. Still other examples are contemplated in which the user may deploy the ribbons 118a-f according to decorative and/or creative techniques.

As will readily be appreciated by a practitioner of ordinary skill in the art after understanding the teachings herein, the ribbon decoration device 10, 110 reduces the labor and skill required to deploy ribbons as decorations (e.g., holiday decorations), and also the labor, skill, and storage space required to retrieve and store the decorations after use. The device is readily manufacturable.

In its various examples and uses, the ribbon decoration device 10, 110 provides a system and method for decorating with ribbon in a manner not previously possible. It provides a system and method that is easily manufactured and used in a variety of different ways. It also provides interchangeability of the number of ribbons to be used, along with their shape, length, width, color, and/or design, which provides a wide range of choices of methods and devices that can be used in decorating with ribbons. It allows for numerous possibilities to use ribbon in decorating. It is a unit that allows for quick and easy decorating using ribbon.

The decorative ribbon or ribbons may be attached or affixed to a base structure at the top of structures such as poles, columns, trees, buildings, windows, doorways, or other such objects (e.g., bridal arches and fixtures) in any desired manner. The decorative ribbon may be attached circumferentially, linearly (diagonally, horizontally, and/or vertically), or on or around any other shape structure.

The decorative ribbons may be attached to the base structure using snaps, studs, pins, clips, hook-and-loop or VELCRO™, stitching, sewing, or other attachment methods known in the art.

The decorative ribbons which stream down from the base structure at the top may provide an attachment at the far end or bottom end that can be employed to attach two or more decorative ribbons to one another in order to lengthen and shorten the ribbon/ribbons to provide for a continuous flow in decorating.

The structural and decorative ribbons may be made from a variety of materials and in a variety of colors and textures, and may or may not match one another. The attachments may be shaped, colored, and/or sized such that they are inconspicuous, or they may be shaped, colored, and/or sized such that they have decorative value as part of the ribbon decoration device.

The operations and elements shown and described herein are provided to illustrate example implementations. It is noted that the operations and elements are not limited to the ordering shown. Still other operations and elements may also be implemented.

Still further operations and elements may include an elastic base structure. The colors and design of the ribbons and/or decorations may be selected for celebrations (e.g., weddings, birthdays, etc.) or organizations (e.g., sports teams, schools, etc.).

It is noted that the examples shown and described are provided for purposes of illustration and are not intended to be limiting. Still other examples are also contemplated.

1. A ribbon decoration device, comprising:
at least a first base structure having a first end, a second end, and a body;
at least one end fastener to attach the first end of the first base structure to the second end of the first base structure;
a plurality of decorative ribbons, each ribbon configurable between a rolled configuration for storage and an unrolled configuration for decorating; and
a plurality of ribbon fasteners, each of the ribbon fasteners configured to attach a corresponding one of the plurality of decorative ribbons to the body of the first base structure;
wherein the first base structure is positioned on a tree, pole, fixture, window, doorway, or other object with the plurality of decorative ribbons in the rolled configuration on the first base structure, and wherein the plurality of decorative ribbons is changed to the unrolled configuration for decorating the tree, pole, fixture, window, doorway, arch, or other object.

2. The device of claim 1, further comprising a plurality of decorative ribbon covers, each configured to retain one of the plurality of decorative ribbons in the rolled-up configuration.

3. The device of claim 2, wherein the one or more decorative ribbon cover fully wraps around one of the plurality of decorative ribbons in the rolled-up configuration.

4. The device of claim 3, wherein each of the plurality of decorative ribbon covers includes a cover fastener to form a closed loop around the one or more of the plurality of decorative ribbons in the rolled-up configuration and retain a corresponding one of the plurality of decorative ribbons therein so as not to unroll while in the rolled configuration.

5. The device of claim 1, further comprising a second base structure for connecting together to the first base structure to form an extended size base structure for use with larger size trees, poles, fixtures, arches or other objects.

6. The device of claim 1, wherein at least two of the plurality of decorative ribbons are attached to one another and a combination of the at least two decorative ribbons form an extended length decorative ribbon. A ribbon decoration device, comprising:
at least one base structure;
a plurality of decorative ribbons, each ribbon configurable between a rolled configuration for storage and an unrolled configuration for decorating; and
a plurality of ribbon fasteners provided on the plurality of decorative ribbons, each of the ribbon fasteners attaching to the at least one base structure;
wherein the at least one base structure is positioned on an object with the plurality of decorative ribbons attached in the rolled configuration on the at least one base structure, and the plurality of decorative ribbons changed to the unrolled configuration for decorating.

8. The device of claim 7, further comprising at least one end fastener to attach a first end of the at least one base structure to a second end of the at least one base structure.

9. The device of claim 7, further comprising a plurality of decorative ribbon covers, each configured to retain one of the plurality of decorative ribbons in the rolled-up configuration.

10. The device of claim 9, wherein the one or more decorative ribbon cover fully wraps around one of the plurality of decorative ribbons in the rolled-up configuration.

11. The device of claim 10, wherein each of the plurality of decorative ribbon covers includes a cover fastener to form a closed loop around the one or more of the plurality of decorative ribbons in the rolled-up configuration and retain a corresponding one of the plurality of decorative ribbons therein so as not to unroll while in the rolled configuration.

12. The device of claim 7, further comprising a first base structure and a second base structure for connecting together to form an extended size base structure.

13. The device of claim 7, wherein at least two of the plurality of decorative ribbons are attached to one another and a combination of the at least two decorative ribbons form an extended length decorative ribbon.

14. A decorating method with a ribbon decoration device, comprising:
providing a base structure;
providing a plurality of decorative ribbons; and
providing a plurality of ribbon fasteners to attach the plurality of decorative ribbons to the base structure;
wherein the base structure is positioned on an object with the plurality of decorative ribbons in a rolled configuration, and wherein the plurality of decorative ribbons are unrolled for decorating the object.

15. The method of claim 14, further comprising providing at least one end fastener to attach a first end of the base structure to a second end of the base structure for positioning the base structure around the object.

16. The method of claim 14, further comprising providing a plurality of decorative ribbon covers configured to retain the plurality of decorative ribbons in the rolled configuration.

17. The method of claim 16, wherein each of the plurality of decorative ribbon covers has a cover fastener to form a closed loop around the plurality of decorative ribbons in the rolled-up configuration to prevent unrolling.

18. The method of claim 14, further comprising connecting the base structure together with another base structure to form an extended base structure.

19. The method of claim 14, further comprising providing at least two decorative ribbons for attaching to one another, wherein the combination of the at least two decorative ribbons form an extended length decorative ribbon.
